(19) United States
(12) Patent Application Publication
(10) Pub. No.: US 2025/0178080 A1
(43) Pub. Date: Jun. 5, 2025

(54) AN ARTICLE COMPRISING A COMPOSITE COMPRISING GRAPHITE

(71) Applicant: Foseco International Limited, Derbyshire (GB)

(72) Inventor: Nagendra Nag, Derbyshire (GB)

(73) Assignee: Foseco International Limited, Derbyshire (GB)

(21) Appl. No.: 18/845,565

(22) PCT Filed: Mar. 11, 2023
(86) PCT No.: PCT/EP2023/056258

§ 371 Date: Sep. 10, 2024

(30) Foreign Application Priority Data
Mar. 11, 2022 (EP) 22161574.3
Feb. 15, 2023 (EP) 23156939.3

(51) Int. Cl. B22D 41/00; C04B 35/626; C04B 35/64; C04B 35/83; C04B 38/00

(52) U.S. Cl. CPC B22D 41/00; C04B 35/62695; C04B 35/64; C04B 35/83; C04B 38/0054; C04B 2235/3821; C04B 2235/3826; C04B 2235/424; C04B 2235/425; C04B 2235/447; C04B 2235/5276; C04B 2235/5292; C04B 2235/77; C04B 2235/9676

(57) ABSTRACT

A method of forming an article that includes a composite including graphite is disclosed. The article is suitable for containing or processing a molten metal such as aluminum. The method includes forming at least one granulated mixture by mixing at least carbon black, flake graphite, needle coke with at least one resin, the at least one resin has a flow distance, as measured by ISO 8619:2003, from 20 mm to 150 mm. The method further includes shaping the granulated mixture into a shaped body and firing the shaped body.

### BACKGROUND

The present disclosure relates to a method of forming an article comprising a composite comprising graphite, and to an article comprising a composite comprising graphite.

Articles of manufacturing such as, for example, refining vessels, transfer vessels and the like, used in molten metal processing have traditionally been made from cast iron which results in a heavy article that absorbs heat. Ceramic fiber vacuum formed articles have been developed to overcome the problems associated with their cast iron counterparts. However, such ceramic fiber formed articles have difficulty meeting fundamental performance requirements. Recently, reinforced fiber materials have been developed as a replacement for both the cast iron and ceramic fiber vacuum formed articles. However, articles made from reinforced fiber materials have a high cost associated therewith or are of low quality. There is thus a need to provide articles of manufacturing that can be used in molten metal applications and other applications which overcome the problems associated with cast iron articles, ceramic fiber vacuum formed articles and reinforced fiber material-containing articles.

### SUMMARY

The present application provides a method of forming an article comprising a composite comprising graphite, wherein said article is suitable for containing or processing a molten metal such as aluminum. The method comprises the steps of:
(a) forming at least one granulated mixture by mixing at least carbon black, flake graphite, needle coke with at least one resin, wherein said resin has a flow distance, as measured by ISO 8619:2003, from 20 mm to 150 mm;
(b) shaping the at least one granulated mixture into at least one shaped; and
(c) firing the at least one shaped body.

The present application provides a method of forming an article comprising a composite comprising graphite suitable for containing or processing a molten metal such as aluminum. Non-limiting examples of such an article are ladles, crucibles, filters, rotors and rotor sub-components, continuous fiber weaves, meshes, machined components, etc. The method of the invention provides an article that has a desired and controlled porosity and graphite alignment. In the rest of the text, the terms “porosity” and “fine porosity” have the same meaning and may be used interchangeably. The method of the present disclosure also enables the formation of an article that has a high strength (for e.g., the composite has a flexural strength from about 10 MPa to 25 MPa or optionally higher) and a non-wetting (i.e., non-stick) surface. These and other aspects of the present disclosure will now be described in greater detail.

### DETAILED DESCRIPTION

The present disclosure will now be described in greater detail by referring to the following discussion and drawings that accompany the present disclosure. In the following description, numerous specific details are set forth, such as particular structures, components, materials, dimensions, processing steps and techniques, in order to provide an understanding of the various embodiments of the present disclosure. However, it will be appreciated by one of ordinary skill in the art that the various embodiments of the present disclosure may be practiced without these specific details. As used throughout the present disclosure, the term “about” generally indicates no more than ±10%, ±5%, ±2%, ±1% or +0.5% from a number. When a range is expressed in the present disclosure as being from one number to another number (e.g., 20 to 40), the present disclose contemplates any numerical value that is within the range (i.e., 22, 24, 26, 28.5, 31, 33.5, 35, 37.7, 39 or 40) or in any amount that is bounded by any of the two values within the range (e.g., 28.5-35).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising”, when used in this disclosure, specify the presence of stated features, integers, steps, operations, elements, and/or components, but do not preclude the presence or addition of one or more other features, integers, steps, operations, elements, components, and/or groups thereof.

Within the context of the present invention, the expression “at least one X” is intended to denote one or more than one X. Mixtures of X can also be used for the purpose of the invention.

The particle sizes provided herein can refer to a diameter for the case where the particle is spherical or substantially spherical. For cases where the particles substantially deviate from a spherical shape, the particle sizes are based on the equivalent diameter of the particles. As is known in the art, the term “equivalent diameter” is used to express the size of the irregularly shaped object by expressing the size of the object in terms of the diameter of a sphere having the same volume as the irregularly shaped object. The particle sizes can also be expressed herein are D50 particle sizes, i.e., half the particles above the expressed value, and the other half is below the expressed value.

According to the invention, the article is suitable for containing or processing a molten metal. Non-limiting example of such article are rotors, ladles, filters, and crucibles or components thereof. The articles are compatible with low-pressure and high-pressure die casting in which molten metal, such as molten aluminum, is used.

The method of the present invention includes a step (a) of forming at least one granulated mixture by mixing at least carbon black, flake graphite, needle coke with at least one resin, wherein said resin has a flow distance, as measured by ISO 8619:2003, from 20 mm to 150 mm. Unless otherwise noted, the flow distance was measured at 125° C.

As used herein, the term “granulated mixture” refers to a blended mixture that includes at least carbon black, flake graphite, and needle coke with the at least one resin.

The inventors have surprisingly found that the carbon black, flake graphite, needle coke provide complimentary shape profiles that provide for a high-degree of compaction when a shaped body is formed from the granulated mixture. When this powder (i.e., carbon black, flake graphite and needle coke) is mixed together with a resin presenting the flow distance as described above, a composite comprising graphite presenting high performance in terms of porosity, density, surface roughness, strength and wettability is achieved.

The inventors have notably found that the method of the invention provides a composite having a pore profile that has a pore volume and a pore size distribution such that at least 95 percent of the total pore volume is contained in pores with a diameter or equivalent diameter of less than 1 μm; in a further embodiment or in the same embodiment, at least 40 percent of the pore volume of the pores having a diameter or equivalent diameter of less than 1 μm is contained in pores having a diameter or equivalent of less than 0.1 μm. The fine pore profile formed in the composite of manufacturing enables significant reduction in the achievable surface roughness of the composite in the article. Within the context of the present invention, the pore profile (pore diameter) is to be understood as the porosity and was measured according to ASTM C830-00(2016) Standard. The pore profile was measured by mercury (Hg) intrusion analysis. The employed device used to perform this analysis was an AutoPore V, Micromeritrics®. In terms of surface roughness Rₐ of the composite resulting from the method of the invention, the method of the invention, allows to achieve a composite having a surface roughness Rₐ between 3.2 μm and 0.025 μm, wherein the surface roughness Rₐ is as provided in ISO 1302:1992 standard. The reduction in surface roughness also influences the adhesion (adhesion energy) or spreading (surface energy) and wetting (contact angle) forces that develop between the molten metal and the manufactured article. This has an important bearing on the performance of the manufactured article as rotating object (e.g., rotor) or as a stationary part (e.g., crucible).

When an article (for e.g., articles of manufacturing) is made from the method according to the invention, a substantially net-shaped article having a non-wetting surface is obtained. By “substantially net-shaped” it is meant that the article that is produced from the method of the present disclosure has a dimension (i.e., size and shape) that is in proximity (at least 90% or greater) to the desired dimension (size and shape) of the finished product or article. By forming substantially net-shaped articles, the production costs and times associated with the fabrication of the final product is greatly reduced.

By “non-wetting surface” it is meant that the article that is produced from the composite of the present disclosure is not infiltrated by molten/liquid metals such as, for example, copper or aluminum, even at high pressure P₀. In graphite articles such as containers carrying molten metals, infiltration of molten metals can be achieved by applying a sufficiency high P₀ to overcome the capillary pressure P_{C}, where P_{C}=−(2σ_{LV}/r_{eff})cos θ, where σ_{LV} is the surface energy of the liquid, r_{eff} is an effective pore radius of the composite and θ is the contact angle of the pore walls. At the effective pore radius of the composite of the present disclosure, the capillary pressure is too large to allow infiltration of the molten metal. Advantageously, in embodiments of the present disclosure, there is little to no attack of the article by molten metals infiltrating through pores even after long molten metal exposure or after repeated exposures to molten metal.

The mixing step (i.e. step (a), as detailed above) can be carried out in different manners. For example, the granulated mixture of the present disclosure can be prepared by first adding the carbon black, the flake graphite, the needle coke, the optional one or more additives as defined below, and the resin. The adding of the various components/raw materials can be performed in any order. For example, and in one embodiment, the carbon black, the flake graphite, the needle coke, the optional one or more additives are added prior to adding the resin. In other embodiments, the resin is added first, and thereafter the carbon black, the flake graphite, the needle coke. Mixing can be performed continuously during the addition of the various components/raw materials, or intermittently during the adding of the various components/raw materials. The various components/raw materials that are used in providing the granulated mixture are in the amounts specified below.

During mixing, the powder particles (i.e., carbon black, flake graphite and needle coke) may be bonded together by the resin thereby forming granules. In this embodiment, mixing can also be called granulation. Preferably, the granules can have a size from about 25 μm to about 4 mm, preferably a granular size from about 70 μm to about 700 μm.

In another embodiment, the process according to the invention can further comprise a granulation step after the mixing step.

In one example, the mixing includes high shear mixing of the raw materials. In one example where a high shear mixing device is used in the mixing process, the resin can aid in the formation or coat agglomerates of the raw materials. The mixing parameters can be altered to increase or decrease the size and distribution of the granules as desired to optimize their use in subsequent processing steps. One example of a high shear mixer could be an Eirich mixer or similar. The mixing process forms the granulated mixture of the present disclosure.

In some embodiments, the granulated mixture has a bimodal granule size distribution with a first set of granules having a granule size diameter from about 50 μm to about 100 μm, and a second set of granules having a granule size diameter from about 110 μm to about 1000 μm. The first set of granules can constitute from about 30 volume percent to about 60 volume percent of the total granulated mixture, while the second set of granules can constitute from about 20 volume percent to about 40 volume percent of the total granulated mixture (as noted elsewhere in this disclosure, the particle sizes expressed herein are D50 particle sizes, i.e., half the particles above the expressed value, and the other half is below the expressed value).

The various components (i.e., raw materials) that can be used in the granulated mixture of the present disclosure will now be described in additional detail.

The carbon black that can be used in the granulated mixture of the present disclosure contains at least 99 weight percent carbon and has an ash content of 1 weight percent or less. Typically, the carbon content within the carbon black that can be used in the present disclosure is from about 99.5 weight percent to about 100 weight percent. The carbon black that can be used in the present application is spherical or substantially spherical in shape; there may be some irregularity within the shape that deviates from being completely spherical. The carbon black that can be used in the present disclosure has a particle size of about 10 μm to about 50 μm, preferably a particle size of about 25 μm to about 40 μm.

Advantageously, the carbon black is present in the granulated mixture in an amount equal to or greater than 2 weight percent, preferably equal to or greater than 3 weight percent, more preferably equal to or greater than 5 weight percent, relative to the total weight of the granulated mixture.

Preferably, the upper limit of the amount of the carbon black in granulated mixture is equal to or less than 15 weight percent, preferably equal to or less than 10 weight percent, more preferably equal to or less than 8 weight percent, relative to the total weight of the granulated mixture.

According to at least one embodiment, the carbon black is present in the granulated mixture in an amount from about 5 weight percent to about 10 weight percent, preferably in an amount from about 5 weight percent to about 8 weight percent, relative to the total weight of the granulated mixture. In the ranges expressed in the present invention, the present disclose contemplates using any numerical value that is within the range, or in any amount that is bounded by any of the two values. For example, the content of carbon black within the granulated mixture can be 5 weight percent, 5.5 weight percent, 6 weight percent, 6.5 weight percent, 7 weight percent, 7.5 weight percent, 8 weight percent, 8.5 weight percent, 9 weight percent, 9.5 weight percent, 10 weight percent or from, for example, 5.5 weight percent to 8.5 weight percent.

The needle coke that can be used in the granulated mixture of the present disclosure contains at least 99 weight percent carbon and has a sulfur content of 1 weight percent or less. Typically, the carbon content within the needle coke that can be used in the present disclosure is from about 99.5 weight percent to about 100 weight percent. The needle coke that can be used in the granulated mixture of the present disclosure is irregular shaped needle coke. By “irregular shaped needle coke” it is meant to have developed from (or possessing a) fibrous, cylindrical, or needle-like structure. The needle coke that can be used in the present disclosure has a particle size of about 10 μm to about 50 μm, with a particle size of about 25 μm to about 40 μm being more typical.

The inventors have identified that needle coke shows similar toughness and increased tolerance to thermal shock as compared to other types of carbon such as, for example, chopped carbon fibers. The inventors have also identified that needle coke manifests superior oxidation resistance as compared to carbon fiber and further that using needle coke (as opposed to carbon fiber) provides superior surface smoothness in the composite comprising graphite formed when the shaped body is fired to provide the composite comprising graphite. Accordingly, the surface smoothness of the composite is improved by the use of needle coke.

Advantageously, the needle coke is present in the granulated mixture in an amount equal to or greater than 0.5 weight percent, preferably equal to or greater than 1 weight percent, more preferably equal to or greater than 2 weight percent, relative to the total weight of the granulated mixture.

Preferably, the upper limit of the amount of the needle coke in granulated mixture is equal to or less than 7 weight percent, preferably equal to or less than 5 weight percent, more preferably equal to or less than 4 weight percent, relative to the total weight of the granulated mixture.

In a preferred embodiment of the invention, the needle coke is present in the granulated mixture in an amount from about 1 weight percent to about 5 weight percent, preferably in an amount from about 2 weight percent to about 4 weight percent, relative to the total weight of the granulated mixture.

The flake graphite that can be used in the granulated mixture of the present disclosures contains at least 95 weight percent carbon and has an ash content of 1 weight percent or less. Typically, the carbon content within the flake graphite that can be used in the present disclosure is from about 95 weight percent to about 99 weight percent. The flake graphite that can be used in the present disclosure has a particle size of about 10 μm to about 500 μm, with a particle size of about 25 μm to about 40 μm being more typical. In one embodiment, the flake graphite that can be used in the granulated mixture of the present disclosures is a naturally occurring type of graphite that is typically in the form of discrete flakes; the discrete flakes can include hexagonal shaped crystals; there may be some irregularity within the shape of the flake graphite crystals that deviate from being completely hexagonal. In one embodiment, the flake graphite that can be used in the granulated mixture of the present disclosures has a distinctly flaky or platy morphology.

Advantageously, the flake graphite is present in the granulated mixture in an amount equal to or greater than 50 weight percent, preferably equal to or greater than 65 weight percent, more preferably equal to or greater than 75 weight percent, relative to the total weight of the granulated mixture.

Preferably, the upper limit of the amount of the flake graphite in granulated mixture is equal to or less than 90 weight percent, preferably equal to or less than 85 weight percent, more preferably equal to or less than 80 weight percent, relative to the total weight of the granulated mixture.

In a preferred embodiment of the invention, the flake graphite is present in the granulated mixture in an amount from about 65 weight percent to about 85 weight percent, preferably in an amount from about 75 weight percent to about 80 weight percent, relative to the total weight of the granulated mixture.

In at least one embodiment, the roughly hexagonal crystal shape of flake graphite, the fibrous, cylindrical, needle-like, or irregular shape of the needle coke, and the substantially spherical shape of carbon black provide complimentary shape profiles that provide for a high-degree of compaction when a shaped body is formed from the granulated mixture.

Preferably, at least a portion of the carbon black has a roughly spherical shape. Preferably, the at least a portion of needle coke has a roughly cylindrical, fibrous or needle profile, Preferably, at least a portion of the flake graphite has a roughly hexagonal or triangular profile.

According to the invention, the resin has a button flow distance, as measured by ISO 8619:2003, from 20 mm up to 150 mm. The skilled in the art will be able to select the appropriate resin in order to obtain the flow distance required by the invention. The inventors have surprisingly found that the granulated mixture of the present disclosure including a resin having a button flow distance, as measured by ISO 8619:2003, from 20 mm up to 150 mm, reduces complexity and steps in the mixing step as compared to prior art binder systems.

Advantageously, the resin has a button flow distance, as measured by ISO 8619:2003, equal to or greater than 20 mm, preferably equal to or greater than 40, more preferably equal to of greater than 70 mm.

Preferably, the upper limit of the flow distance of the resin, as measured by ISO 8619:2003, is equal to or less than 150 mm, preferably equal to or less than 70 mm, more preferably equal to or less than 40 mm.

In a preferred embodiment of the invention, the resin has a button flow distance, as measured by ISO 8619:2003, from 70 mm up to 150 mm, preferably from 40 mm to 70 mm, more preferably from 20 mm up to 40 mm

In one embodiment of the method according to the invention, resin that can be employed has a button flow distance, as measured by ISO 8619:2003, from 70 mm up to 150 mm. Resins having such flow distances can be characterized herein as “low molecular weight resins”. In another embodiment of the present disclosure, the resin that can be employed in the present disclosure has a button flow distance, as measured by ISO 8619:2003, from 40 mm to 70 mm. Resins having such flow distances can be characterized herein as “medium molecular weight resins”. In yet another embodiment of the present disclosure, the resin that can be employed in the present disclosure has a button flow distance, as measured by ISO 8619:2003, from 20 mm up to 70 mm. Resins having such flow distances can be characterized herein as “high molecular weight resins”. In yet other embodiments of the present disclosure, any combination of low molecular weight resins, medium molecular weight resins, high molecular weight resins can be employed.

It is noted that the type of resin (i.e., low, medium, and high molecular weight resin as defined above) can be selected to control the overall viscosity of the binder system. It is further noted that the type of resin (i.e., low, medium, and high molecular weight resin as defined above) affects the strength of the green body. For example, high molecular weight resins, as defined herein, provide the highest strength green body (above 2 MPa of flexural strength), medium molecular weight resins, as defined herein, provide a medium strength green body (of from 1 MPa to 2 MPa of flexural strength), and low molecular weight resins, as defined herein, provide a lowest strength green body (less than <1 MPa of flexural strength). The green body represents the granulated mixture after shaping and prior to firing.

It is noted that the resin of the present disclosure, aids in the granulated mixture step of forming the granulated mixture. The organics of the resin are typically removed during the firing process.

Preferably, the resin is chosen to have a viscosity from about 9000 cps to about 30,000,000 cps. More preferably, the resin is chosen to have a viscosity from about 9000 cps to about 150,000 cps. Unless otherwise noted, the viscosity was measured at 25° C.

Advantageously, the resin is present in the granulated mixture in an amount equal to or greater than 2 weight percent, preferably equal to or greater than 4 weight percent, more preferably equal to or greater than 6 weight percent, relative to the total weight of the granulated mixture.

Preferably, the upper limit of the amount of the resin in granulated mixture is equal to or less than 15 weight percent, preferably equal to or less than 10 weight percent, more preferably equal to or less than 8 weight percent, relative to the total weight of the granulated mixture.

In a preferred embodiment of the invention, the resin is present in the granulated mixture in an amount from about 2 weight percent to about 10 weight percent, preferably in an amount from about 6 weight percent to about 8 weight percent, relative to the total weight of the granulated mixture.

Within the context of the present invention, the resin can be in various physical states, preferably, the resin is in liquid state.

Preferably, the resin is a thermosetting resin.

The choice of the resin is advantageously determined by having a high char yield after pyrolysis. Table 1 below lists the typical char yield after pyrolysis of various carbon source materials. Preferably, the resin provides a high char yield after pyrolysis equal to or greater than 40 weight percent, or equal to or greater than 50 weight percent, or equal to or greater than 60 weight percent.

TABLE 1

| | Typical Char Yield after |
|---|---|
| Carbon Source | Pyrolysis wt % |
| Coal-tar pitch | 45-55 |
| Phenolic resin | 40-70 |
| Furanic resin | 45-60 |
| Polyacrilonitrile (PAN) cellulose | 35-45 |
| Epoxy resin | 25-35 |
| Unsaturated polyester resin | 15-25 |
| Polypropylene (PP) | <2 |
| Poly-ethylene terephthalate (PET) | <0.5 |

As the skilled person understands, when the shaped body is fired to high temperatures, the amorphous carbon (i.e., the amorphous carbon resulting from the conversion of resin when the shaped body is fired to provide the composite comprising graphite) can further reform itself into other forms of carbon such as, for e.g., crystallized carbon in form of nanotubes of carbon, graphene, and similar other materials.

Advantageously, the resin is selected from the group consisting of phenolic resins, cellulose based derivatives, siloxane modified resins, modified epoxy resins, polyimides, benzoxazines, or any combination thereof. Non-limiting examples of commercial polyimides are ZT1000 [Polyimides] and Cornerstone (18C021). A non-limiting example of commercial benzoxazines is Huntsman (18B028). In some embodiments, the resin additionally includes an additive such as carbores. More preferably, the resin is a phenolic resin. One advantage of using phenolic resin is that up to 70 wt % of the phenolic resin can convert to carbon in the form of amorphous carbon, for example, when the shaped body is fired to provide the composite comprising graphite.

In a preferred embodiment of the invention, the resin can be formed by the condensation of phenol, or of a phenol derivative, with aldehyde, especially formaldehyde, in the presence of a catalyst. In one embodiment of the present disclosure, the phenolic resin that can be employed in the present disclosure has a button flow distance, as measured by ISO 8619:2003, from 70 mm up to 150 mm. Phenolic resins having such flow distances can be characterized herein as “low molecular weight phenolic resins”. In another embodiment of the present disclosure, the phenolic resin that can be employed in the present disclosure has a button flow distance, as measured by ISO 8619:2003, from 40 mm to 70 mm. Phenolic resins having such flow distances can be characterized herein as “medium molecular weight phenolic resins”. In yet another embodiment of the present disclosure, the phenolic resin that can be employed in the present disclosure has a button flow distance, as measured by ISO 8619:2003, from 20 mm up to 70 mm. Phenolic resins having such flow distances can be characterized herein as “high molecular weight phenolic resins”. In one example, the phenolic resin that can be used in the present disclosure is a commercially available phenolic resin referred to as Sumitomo XF3011P. In yet another embodiment of the present disclosure, the phenolic resin that is employed is a liquid phenolic resin. In yet other embodiments of the present disclosure, any combination of low molecular weight phenolic resins, medium molecular weight phenolic resins, high molecular weight phenolic resins, or liquid phenolic resins can be employed.

According to at least one embodiment, to further improve the flowability and/or the viscosity of the resin, at least one solvent can be added to the resin. In this embodiment, the resin can also be referred to as a binder system, which consists in the at least one resin and the at least one solvent. It is noted that the type of resin and the type of solvent can be selected to control the overall viscosity of the binder system. According to at least one embodiment, the solvent comprises a dibasic ester. In one embodiment, the solvent can be a dibasic ester, which is an ester of dicarboxylic acid having the formula CH₃O₂C(CH₂)ₙCO₂CH₃, wherein n is equal to 2, 3 or 4. In some embodiments, the solvent used is an acetate. In further embodiments, the acetate is propylene glycol diacetate. Other solvents are possible and can be used in conjunction with the resin as the binder system of the present disclosure. In accordance with an embodiment of the present disclosure, the resin and the solvent are present in the granulated mixture in a weight ratio of from about 1:1 to about 6:1. In accordance with another embodiment of the present disclosure, the resin and solvent are present in the granulated mixture in a weight ratio of from about 2:1 to about 4:1. When the resin further comprises a solvent, the solvent is present in the granulated mixture in an amount from about 1 weight percent to about 5 weight percent, preferably in an amount from about 3 weight percent to about 4 weight percent, relative to the total weight of the granulated mixture.

In some embodiments, the resin of the granulated mixture additionally includes an optional binder plasticizer. Accordingly, in some embodiments, the resin can further include a binder plasticizer such as, for example, dextrin, propylene carbonate, stearic acid, oleic acid, glydol, and/or triacetin; in other embodiments, no binder plasticizer is employed.

In some embodiments, the granulated mixture of the present disclosure is devoid of any intentionally added water. In yet other embodiments, water can be included in the granulated mixture of the present disclosure. In some embodiments of the present disclosure, the granulated mixture has a moisture content of less than about 5.0 weight percent, preferably equal to or less than 4.0 weight percent, more preferably equal to or less than 3.0 weight percent, relative to the total weight of the granulated mixture. Advantageously, the granulated mixture has a moisture content equal to or greater than 0.5 weight percent, preferably equal to or greater than 1 weight percent, more preferably equal to or greater than 2.0 weight percent, relative to the total weight of the granulated mixture. In one example, the moisture content of the granulated mixture is from about 1.0 weight percent to 4.0 weight percent, relative to the total weight of the granulated mixture.

According to at least one embodiment, the carbon black, the flake graphite, the needle coke, and the resin provide 100 percent of a total weight of the granulated mixture. In this embodiment, the granulated mixture is composed totally of the carbon black, the flake graphite, the needle coke, and the resin; no other components/additives are employed in providing the granulated mixture. This embodiment may advantageously be used to fabricate articles where presence of foreign materials other than carbon is not desired such as, for e.g., crucibles used in the fabrication of synthetic graphite.

In one embodiment, the granulated mixture includes about 6 weight percent, 6.2 weight percent, 6.4 weight percent, 6.6 weight percent, 6.8 weight percent, 7 weight percent, 7.2 weight percent, 7.5 weight percent or within a range bounded by any two of the foregoing values of carbon black, about 1 weight percent, 1.2 weight percent, 1.4 weight percent, 1.6 weight percent, 1.8 weight percent, 2 weight percent, 2.2 weight percent, 2.5 weight percent or within a range bounded by any two of the foregoing values of needle coke, about 78 weight percent, 78.2 weight percent, 78.4 weight percent, 78.6 weight percent, 78.8 weight percent, 79 weight percent, 79.2 weight percent, 79.5 weight percent or within a range bounded by any two of the foregoing values of flake graphite and about 7 weight percent, 7.2 weight percent, 7.4 weight percent, 7.6 weight percent, 7.8 weight percent, 8 weight percent, 8.2 weight percent 8.4 weight percent or within a range bounded by any two of the foregoing values of resin. When the granulated further contains a solvent, and about 3 weight percent, 3.2 weight percent, 3.4 weight percent, 3.6 weight percent, the granulated mixture further includes about 3.8 weight percent, 4 weight percent, 4.2 weight percent, 4.5 weight percent or within a range bounded by any two of the foregoing values of solvent.

In other embodiments, the granulated mixture further includes one or more of: an anti-oxidation additive, a toughening/strength enhancing additive, a wear/erosion resistance agent, a thermal insulation enhancing agent, and a transition metal selected from Group 4 to Group 12 of the Periodic Table of Elements. These additives can take the form of a powder or the form of grains.

According to at least one embodiment, the granulated mixture further comprises from about 5 weight percent to about 15 weight percent, preferably from about 8 weight percent to about 12 weight percent of an anti-oxidation additive, relative to the total weight of the granulated mixture. According to at least one embodiment, the anti-oxidation additive comprises boron carbide, silicon carbide, aluminum-zinc phosphate, or any combination thereof.

The anti-oxidation additive serves to decrease the oxidation of the resultant composite, while blocking the pores and increasing the bulk density of the resultant composite. Illustrative anti-oxidation additives that can be present in the granulated mixture of the present disclosure include, but are not limited to, boron carbide, silicon carbide, bentonite, aluminum-zinc phosphate, or any combination thereof. In one embodiment, the anti-oxidation additive includes a mixture of from about 2 weight percent to about 7 weight percent of boron carbide, from about 1 weight percent to about 5 weight percent of silicon carbide, from about 0.25 weight percent to about 0.75 weight percent of bentonite, and from about 2 weight percent to about 5 weight percent of aluminum-zinc phosphate, relative to the total weight of the anti-oxidation additive.

In some embodiments where boron carbide is employed as anti-oxidation additive, the boron carbide is provided in the form of fine particles having a particle size of less than about 50 μm, preferably with a particle size within the range from about 25 μm to about 40 μm. In some embodiments in which silicon carbide is employed as anti-oxidation additive, silicon carbide is provided in the form of fine particles having a particle size of less than about 50 μm, preferably with a particle size within the range from about 20 μm to about 40 μm. In some embodiments where bentonite is employed as anti-oxidation additive, bentonite is provided in the form of fine particles having a particle size of less than about 10 μm, preferably with a particle size within the range from about 1 μm to about 7 μm. In various embodiments, boron carbide, silicon carbide and bentonite can take the form of a powder or the form of grains.

In some embodiments, the addition of the anti-oxidation can take place at two separate or different stages. In an embodiment where anti-oxidation addition takes place in two stages, during the first stage of the two stages, a first stage anti-oxidation additive is added to the granulated mixture. The granulated mixture is then shaped into a shaped body composed of the granulated mixture. In a second stage of the two stages, a second stage anti-oxidation additive is applied to a portion or the whole of the exposed surface(s) of the shaped body followed by firing the shaped body to provide a composite composed of graphite. In some embodiments, the first stage anti-oxidation additive added in the first stage is of a different material as compared to the second stage anti-oxidation additive added in the second stage. In some embodiments, the first stage anti-oxidation additive added in the first stage is of the same material as the second stage anti-oxidation additive added in the second stage.

According to at least one embodiment, the granulated mixture further comprises from about 1 weight percent to about 5 weight percent, preferably from about 2.5 weight percent to about 4.5 weight percent of a toughening/strength enhancing additive, relative to the total weight of the granulated mixture. According to at least one embodiment, the toughening/strength enhancing additive comprises carbon fibers, chopped carbon fiber bundles, basalt bundles, alumina silicate fibers, chopped steel fibers or any combination thereof.

The toughening/strength enhancing additives serve to increase the toughness and/or strength of the resultant composite. Illustrative toughening/strength enhancing additives that can be present in the granulated mixture of the present disclosure include, but are not limited to, carbon fibers, chopped carbon fiber bundles, basalt bundles, alumina silicate fibers, chopped steel fibers or any combination thereof. In some embodiments, the toughening/strength enhancing additive includes carbon fibers, chopped carbon fiber bundles or a combination thereof; such toughening/strength enhancing additives increase the toughness of the resultant article of manufacturing which is made from the granulated mixture of the present application. In some embodiments, the toughening/strength enhancing additive includes basalt, alumina silicate fibers or a combination thereof; such toughening/strength enhancing additives improve the strength and decrease the thermal conductivity of the resultant article of manufacturing which is made from the granulated mixture of the present application. In some embodiments, the toughening/strength enhancing additive includes chopped steel fibers; such a toughening/strength enhancing additive include increases the strength and toughness of the resultant article of manufacturing which is made from the granulated mixture of the present disclosure.

According to at least one embodiment, the granulated mixture further comprises from about 1 weight percent to about 10 weight percent, preferably from about 4.5 weight percent to about 8.5 weight percent of a wear/erosion resistance agent, relative to the total weight of the granulated mixture. According to at least one embodiment, the wear/erosion resistance agent comprises a metal oxide, a metal nitride, a metal boride, or any combination thereof.

The wear/erosion resistance agents serve to increase the wear and/or decrease the erosion of the resultant composite. Illustrative examples of wear/erosion resistance agents that can be employed in the present application include a metal oxide (such as, for example, zirconium oxide, or yttrium oxide), a metal nitride (such as, for example, boron nitride, aluminum nitride, or silicon nitride) a metal boride (such as, for example, titanium diboride) or any combination thereof. In some embodiments, zirconium oxide is used as the wear/erosion resistance agent. In such embodiments, the zirconium oxide can form zirconium silicide or zirconium silicate in-situ which can lead to strong bonding, high oxygen resistance, high wear/erosion resistance and/or a very fine pore profile. In such embodiments, the zirconium oxide can form zirconium boride which has an exceptionally high wear/erosion resistance. The wear/erosion resistance agents that can be employed in the present disclosure are typically nano-micron sized powders having a particle size of less than about 40 μm, with a particle size within the range from about 5 μm to about 25 μm being more typical.

According to at least one embodiment, the granulated mixture further comprises from about 1 weight percent to about 5 weight percent, preferably from 2.5 weight percent to 4 weight percent of a thermal insulation enhancing agent, relative to the total weight of the granulated mixture. These agents provide improved thermal insulation to the resultant composite. Illustrative examples of thermal insulation enhancing agents that can be employed in the present disclosure include, but are not limited to, colloidal silica shots, fibers, or a mixture thereof. According to at least one embodiment, the thermal insulation enhancing agent comprises colloidal silica shots, fibers, or a mixture thereof. According to at least one embodiment, the thermal insulation enhancing agent comprises a mixture of sodium alumino silicate shots and chopped silica fibers. According to at least one embodiment, optionally the thermal insulation enhancing agent comprises colloidal silica shots, preferably alumino colloidal silicate shots, fibers, preferably a mixture of sodium and chopped silica fibers, or a mixture thereof. In such embodiments, the mixture can include from about 5 weight percent to about 50 weight percent of sodium alumino silicate shots and from about 20 weight percent to about 70 weight percent of chopped silica fibers, relative to the total weight of the thermal insulation enhancing agent.

According to at least one embodiment, the granulated mixture further comprises from about 1 weight percent to about 5 weight percent, preferably from 2.5 weight percent to about 4 weight percent, of a transition metal selected from Group 4 to Group 12 of the Periodic Table of Elements, relative to the total weight of the granulated mixture. The transition metal can be used to add a specific functionality (such as a catalytical functionality) to the resultant composite. Illustrative examples of suitable transition metals that can be employed in the present disclosure include, but are not limited to, iron, titanium, nickel, or any combination thereof.

In some embodiments, clay can also be present in the granulated mixture of the present disclosure; when clay is present, the clay is preferably present in an amount from about 0.25 weight percent to about 0.75 weight percent, relative to the total weight of the granulated mixture.

In embodiments in which the mixing step provides granules and the granulated mixture includes a toughening/strength enhancing additive as defined above, a wear/erosion resistance agent as defined above, a thermal insulation enhancing agent as defined above, a transition metal as defined above or any combination thereof, those additives can be located within (dispersed in) the granules of the granulated mixture, or those additives can be located between the granules of the granulated mixture.

According to at least one embodiment, the granulated mixture, as detailed above, consists essentially of granules and wherein the toughening/strength enhancing additive, the wear/erosion resistance agent, the thermal insulation enhancing agent, the transition metal selected from Group 4 to Group 12 of the Periodic Table of Elements, or any combination thereof is located within the granules. According to at least one embodiment, the granulated mixture, as detailed above, consists essentially of granules and wherein the toughening/strength enhancing additive, the wear/erosion resistance agent, the thermal insulation enhancing agent, the transition metal selected from Group 4 to Group 12 of the Periodic Table of Elements, or any combination thereof is located between the granules of the granulated mixture.

In some embodiments of the present disclosure, the granulated mixture includes from about 5 weight percent to about 10 weight percent of carbon black, from about 65 weight percent to about 85 weight percent of flake graphite, from about 1 weight percent to about 5 weight percent of needle coke, from about 2 weight percent to about 10 weight percent of the phenolic resin, and from about 1 weight percent to about 5 weight percent of the solvent. In yet other embodiments, the granulated mixture includes from about 5 weight percent to about 8 weight percent of carbon black, from about 75 weight percent to about 80 weight percent of flake graphite, from about 2 weight percent to about 4 weight percent of needle coke, from about 6 weight percent to about 8 weight percent of the phenolic resin, and from about 3 weight percent to about 4 weight percent of the solvent. In the above expressed ranges, the present disclose contemplates using any numerical value that is within the range, or in any amount that is bounded by any of the two values. For example, the content of carbon black within the granulated mixture can be 5 weight percent, 5.5 weight percent, 6 weight percent, 6.5 weight percent, 7 weight percent, 7.5 weight percent, 8 weight percent, 8.5 weight percent, 9 weight percent, 9.5 weight percent, 10 weight percent or from, for example, 5.5 weight percent to 8.5 weight percent.

After forming the granulated mixture (i.e. step (a), as detailed above), the granulated mixture is shaped into a shaped body (i.e. step (b)); this shaped body can be referred to as a green body. Shaping can include, but is not limited to isopressing (i.e., isostatic pressing), hydraulic pressing, extruding, molding or 3D printing. In some embodiments, shaping can be determined by the amount of resin present in the granulated mixture. For example, 4 wt. % to 8 wt. % resin in a granulated mixture can be advantageous for isopressing, or hydraulic pressing; 8 wt. % to 12 wt. % resin can be advantageous for extruding; whilst 12 wt. % to 17 wt. % resin can be advantageous for 3D printing. In some embodiments, shaping of the granulated mixture into a shaped body comprises the following: machining or net shaping the granulated mixture to form a rotor component; shaping the granulated mixture into a ladle; shaping the granulated mixture to form a crucible and extruding or 3D printing of the granulated mixture to form a crucible. In one example, the granulated mixture can be subjected to isopressing using shaped polyurethane bags pressed against a metal mandrel. The shaped body can comprise any shape including, for example, a shape of a rotor or a rotor component, ladle, crucible and a molten metal filter or filter component. In some embodiments, the shaped body can be formed on a prefabricated structure such as, for example, steel meshes, filters or filter components, and continuous carbon weaves, prior to firing.

The inventors have found that the method of the invention provides a shaped body having a green strength from about 1 MPa to about 5 MPa of flexural strength, a green density from about 1.5 g/cm³ to about 1.7 g/cm³, and a powder fill density from about 0.5 g/cm³ to about 0.7 g/cm³. In the present disclosure, green strength can be measured by 3-point bend testing of a test piece (e.g., to measure the flexural strength), green density can be measured by volumetric and weight measurements of a test piece, and powder fill density can be measured by measuring the weight of powder that fills a vessel of known volume. As used herein “green strength” can denote the strength of a material as is processed to form its ultimate fracture strength. As used herein “green density” is the density of the shaped body prior to any heat treatment.

Preferably, when shaping is isopressing (i.e., isostatic pressing), during the mixing step (i.e. step (a), as detailed above), the powder particles (i.e., carbon black, flake graphite and needle coke) may be bonded together by the resin thereby forming granules. In this embodiment, mixing can also be called granulation.

In some embodiments, the shaped body can comprise a crucible shape, wherein said crucible shape is comprised of a plurality of crucible rings which are stacked uniformly on top of one another in order to provide the crucible shape. The crucible rings are preferably obtained by net shaping the granulated mixture into precise ring shapes or shaping the granulated mixture into a large crucible shape, cutting the large crucible shape into crucible rings and machining said crucible rings. This shaping is particularly advantageous because it allows for part-replacement of a crucible rather than having to replace the whole crucible, thereby increasing repair time, decreasing cost and improving overall efficiency.

In some embodiments, the shaped body can be cured prior to firing. Curing of the shaped body prior to firing causes crosslinking of the resin which allows for improved manipulation and handling of the shaped body prior to firing. Curing can be performed in air prior to firing. Curing can be performed at single curing temperature or various curing temperatures can be used. In one embodiment of the present disclosure, curing is performed at a temperature from about 200° C. to about 300° C. and for a time period from about 1 to about 5 hours. Other curing temperatures and/or times can be used in the present disclosure. Curing can be performed in any curing apparatus generally used in the art.

In some embodiments of the present disclosure, the shaped body can be subjected to a coating process, a glazing process, an impregnation process, an infiltration process, or any combination thereof prior to firing. The coating process, glazing process, impregnation process and/or infiltration process can be performed directly to the shaped body, or such processes can be performed on a shaped body that has been first subjected to curing.

When a coating process is performed, at least part of the cured or uncured shaped body can be coated with any suitable coating material utilizing any well-known coating technique such as, for example, spraying, dipping, brushing, etc. In some embodiments, a silicon carbide (SiC), alumina or alumina-titanate coating can be formed on at least part of the cured or uncured shaped body. In some embodiments, a boron nitride coating can be formed on at least part of the cured or uncured shaped body. The coating can modify the porosity and/or finish of the composite.

When a glazing process is performed, at least part of the cured or uncured shaped body can be glazed with any suitable glazing material utilizing any well-known glazing technique such as, for example, spraying, dipping, brushing, etc. In one example, a glazing material formulated from a frit-based composition can be employed.

When an impregnation process is performed, a material can be impregnated into at least part of the cured or uncured and shaped body utilizing any well-known impregnation process such as, for example, roller impregnation, cascade impregnation and dip impregnation can be used. In one example, a borax mixture can be impregnated into at least part of the cured and/or uncured shaped body prior to firing. In one embodiment, at least part of the shaped body composed of the granulated mixture is coated with an impregnation material (for e.g., an anti-oxidation additive) followed by firing the shaped body being wherein the impregnation material (for e.g., and anti-oxidation additive) is impregnated into the composite composed of graphite that results from firing the shaped body.

When an infiltration process is performed, at least part of the cured or uncured shaped body can be infiltrated with any suitable material utilizing any well-known infiltration technique such as, for example, injection, chemical vapor infiltration, etc. Preferably, at least part of the cured or uncured shaped body is infiltrated with a siloxane, a selected phosphate solution or any combination thereof prior to, or after, the firing step. In one example, a siloxane precursor, selected phosphate solution or any combination thereof can be infiltrated into at least part of the shaped body prior to firing. In some embodiments, at least part of the composite is infiltrated with a siloxane, a selected phosphate solution or any combination thereof prior to, or after, the firing step. In one example, a siloxane precursor, selected phosphate solution or any combination thereof can be infiltrated into at least part of said composite after firing. In one embodiment, at least part of the shaped body composed of the granulated mixture is infiltrated with an infiltration material (for e.g., an anti-oxidation additive) followed by firing the shaped body being wherein the infiltration material (for e.g., and anti-oxidation additive) infiltrates into the composite comprising graphite that results from firing the shaped body.

Next, the shaped body is fired to provide a composite comprising graphite (i.e. step (c)). The firing of the shaped body that contains the granulated mixture of the present disclosure provides a composite comprising graphite. The composite can also be an article consisting of the composite. Alternatively, the composite can be further subjected to steps of manufacturing to provide an article comprising the composite. This article can consist of a plurality of composites which are stacked together in order to provide the article. For example, when the article is a crucible, said crucible can consist of a plurality of crucible rings which are stacked uniformly on top of one another in order to provide the crucible. Alternatively or additionally, the composite can be subjected to a coating process, a glazing process, an impregnation process and/or an infiltration process to provide the article. Non-limiting examples of such an article include rotors, ladles, filters, and crucibles or components thereof.

The inventors have found that the method of the invention provides a composite comprising graphite having improved properties such has a porosity from about 10 percent to about 25 percent. Also, the composite obtained by the process of the invention has a bulk density from about 1.6 g/cm³ to about 1.92 g/cm³. Advantageously, the composite has a total pore volume and a pore size distribution wherein at least 95 percent of the total pore volume is contained in pores with a diameter or equivalent diameter of less than 1 μm, and at least 40 percent of the pore volume of the pores having a diameter or equivalent diameter of less than 1 μm is contained in pores having a diameter or equivalent diameter of less than 0.1 μm. The fine pore profile formed in the composite in the article of manufacturing enables significant reduction in the achievable surface roughness of the composite in the article. In terms of surface roughness Rₐ of the composite resulting from the firing of the shaped body, ISO 1302:1992 provides a method of indicating surface roughness. Indeed, average roughness (Rₐ) is often used in the industry as a measure of the surface smoothness. With the method of the invention, it is possible to achieve a composite having a surface roughness Rₐ between 3.2 μm and 0.025 μm, wherein the surface roughness Rₐ is as provided in ISO 1302:1992 standard. The reduction in surface roughness also influences the adhesion (adhesion energy) or spreading (surface energy) and wetting (contact angle) forces that develop between the molten metal and the manufactured article. This has an important bearing on the performance of the manufactured article as rotating object (e.g., rotor) or as a stationary part (e.g., crucible). Moreover, it is possible, according to the invention to provide an article (for e.g., articles of manufacturing) which is a substantially net-shaped article and which has a non-wetting surface, as described above.

Firing can be performed at a single firing temperature or various firing temperatures can be used. In one embodiment, the firing is performed at a temperature from about 800° C. to about 1500° C. In one embodiment, the firing temperature is between 800-1300° C. In one embodiment, the firing temperature is from about 1250° C. to about 1300° C., preferably from about 1000° C. to about 1250° C. In one embodiment, the firing temperature is from about 1400° C. to about 1500° C. In one embodiment, the firing temperature is about 1250° C. In one embodiment, the firing temperature is about 1050° C.

The time period of the firing may vary depending on the temperature of the firing process and the exact make-up of the shaped body. In one example, and within the temperature from about 1250° C. to about 1500° C., firing can be performed for a time period from 5 hours to 50 hours including the time to ramp to peak temperature and hold times. The firing can be performed in various ambient conditions such as for example in a reducing environment or in a carbon environment such as, for example, carbon monoxide. The carbon environment can be mixed with an inert carrier gas (i.e., helium, argon, and/or nitrogen).

Various firing profiles can be used in the present disclosure. In one example, firing of a glazed shaped body can be performed in a reducing atmosphere at a temperature from about 1250° C. to about 1300° C. In another example, and for a glazed/coated shaped body, firing in air at a temperature from about 1000° C. to about 1250° C. can be employed. In a further example, a coated or non-coated shaped body can be fired in reducing environment at a temperature from about 1400° C. to about 1500° C.

In some embodiments, a firing stage anti-oxidation additive (may be alternately referred to herein as the second stage anti-oxidation additive) can be added to the shaped article during the firing process. Illustrative examples of firing stage anti-oxidation additives that can be employed in the present disclosure include, but are not limited to, bentonite, zinc phosphate, aluminum phosphate, aluminum-zinc phosphate, or any combination thereof. The firing stage anti-oxidation additive can be added in amount from about 1 weight percent to about 6 weight percent, with a range from about 2 weight percent to about 4 weight percent being more typical. In some embodiments, the firing stage anti-oxidation additive is the sole anti-oxidation additive present. In other embodiments, the firing stage anti-oxidation additive is used in conjunction with an anti-oxidation additive that is added to form the granulated mixture. In such an embodiment, the anti-oxidation additive that is added to form the granulated mixture can be referred to as the first stage anti-oxidation additive set that includes boron carbide, silicon carbide, bentonite, aluminum-zinc phosphate or any combination thereof as defined above, while the firing stage anti-oxidation additive can be referred to as the second stage anti-oxidation additive set, different from the first anti-oxidation additive set, and includes bentonite, zinc phosphate, aluminum phosphate, aluminum-zinc phosphate or any combination thereof.

In various embodiments, the firing of the shaped body (that contains the granulated mixture of the present disclosure) provides a composite comprising graphite with the fine pore profile wherein at least 95 percent of the total pore volume is contained in pores with a diameter of less than 1 μm, and at least 40 percent of the pore volume of the pores having a diameter of less than 1 μm is contained in pores having a diameter of less than 0.1 μm. This fine pore profile formed in the composite of the present disclosure results in superior surface smoothness of the composite or of the article formed from the composite. In terms of surface roughness Rₐ of the composite resulting from the firing of the shaped body, ISO 1302:1992 provides a method of indicating surface roughness. Indeed, average roughness (Rₐ) is often used in the industry as a measure of the surface smoothness.

In some embodiments of the present disclosure, the method of the invention further comprises a step of coating, glazing, impregnating, infiltrating, or any combination thereof, as described above, prior to or after to the firing step. Preferably, when a coating step is provided, at least part of the composite is coated by a coating. In other words at least part of the surface of the composite is coated with a coating. Advantageously, the coating is at least one selected from the group comprising: boron nitride, silicon carbide, alumina or alumina-titanate.

According to at least one embodiment, when a infiltrating step is provided, at least part of the composite is infiltrated with a siloxane, a selected phosphate solution or any combination thereof prior to, or after, the firing step.

In another aspect of the present disclosure, a composite comprising graphite is provided. Further, an article comprising said composite comprising graphite is provided. As described above, the composite can also be an article consisting of the composite. Alternatively, the composite can be further subjected to steps of manufacturing to provide an article comprising the composite. Non-limiting examples of such an article include rotors, ladles, filters, and crucibles or components thereof. In a preferred embodiment of the invention, the article is a crucible, said crucible being comprised of a plurality of crucible rings which are stacked uniformly on top of one another in order to provide the crucible. Alternatively or additionally, the composite can be further subjected to a coating process, a glazing process, an impregnation process and/or an infiltration process to provide the article.

This composite has a total pore volume and a pore size distribution wherein at least 95 percent of the total pore volume is contained in pores with a diameter or equivalent diameter of less than 1 μm, and at least 40 percent of the pore volume of the pores having a diameter or equivalent diameter of less than 1 μm is contained in pores having a diameter or equivalent diameter of less than 0.1 μm. Preferably, the composite has a total pore volume and a pore size distribution wherein at least 97 percent of the total pore volume is contained in pores with a diameter of less than 1 μm, and at least 40 percent of the pore volume of the pores having a diameter of less than 1 μm is contained in pores having a diameter of less than 0.1 μm.

Such a pore profile can be seen on the right-hand side of FIG. 1 entitled ‘pore size in fired graphite mix’. The fine pore profile formed in the composite in the article of manufacturing enables a significant reduction in the achievable surface roughness of the composite in the article. The reduction in surface roughness also influences the adhesion (adhesion energy) or spreading (surface energy) and wetting (contact angle) forces that develop between the molten metal and the manufactured article. This has an important bearing on the performance of the manufactured article as rotating object (e.g., rotor) or as a stationary part (e.g., crucible).

It is further understood that all definitions and preferences, as described above, equally apply for the composite comprising graphite and for the article.

Preferably, this composite has a porosity from about 10 percent to about 25 percent, more preferably from about 15 percent to about 20 percent.

Preferably, the composite has a bulk density from about 1.6 g/cm³ to about 1.92 g/cm³, more preferably, from about 1.7 g/cm³ to about 1.8 g/cm³.

In some embodiments, the composite of the present disclosure has a fine porosity from about 15 percent to about 20 percent, a density from about 1.7 g/cm³ to about 1.8 g/cm³, and a total pore volume and a pore size distribution wherein at least 97 percent of the total pore volume is contained in pores with a diameter of less than 1 μm, and at least 40 percent of the pore volume of the pores having a diameter of less than 1 μm is contained in pores having a diameter of less than 0.1 μm.

Preferably, the composite of the present invention comprises graphite in an amount of at least 65 weight percent, preferably at least 75 weight percent, more preferably at least 85 weight percent, relative to the total weight of the composite. In some embodiments the composite of the present invention comprises graphite in an amount from about 65 weight percent to about 85 weight percent, preferably in an amount from about 75 weight percent to about 80 weight percent, relative to the total weight of the composite.

According to at least one embodiment, the composite has a surface roughness Rₐ between 3.2 μm and 0.025 μm, wherein the surface roughness Rₐ is as provided in ISO 1302:1992 standard.

Table 2 below provides equivalent values for Ra and N numbers prescribed by the ISO 1302:1992 standard. Table 2 further provides the Ra values in micro inch or μin. under the ANSI B46.1 standard optionally used in the US.

TABLE 2

| | Roughness | Roughness | | CLA | |
|---|---|---|---|---|---|
| Roughness | values | values | | (μin.)- | |
| N-ISO | Ra - | Ra - | | Center | Rt - |
| Grade | micrometers | micrometers | | Line | Roughness, |
| Numbers | (μm) | (μm) | RMS | Avg. | microns |
| N12 | 50 | 2000 | 2200 | 2000 | 200 |
| N11 | 25 | 1000 | 1100 | 1000 | 100 |
| N10 | 12.5 | 500 | 550 | 500 | 50 |
| N9 | 6.3 | 250 | 275 | 250 | 25 |
| N8 | 3.2 | 125 | 137.5 | 125 | 13 |
| N7 | 1.6 | 63 | 64.3 | 63 | 8.0 |
| N6 | 0.8 | 32 | 32.5 | 32 | 4.0 |
| N5 | 0.4 | 16 | 17.6 | 16 | 2.0 |
| N4 | 0.2 | 8 | 8.8 | 8 | 1.2 |
| N3 | 0.1 | 4 | 4.4 | 4 | 0.8 |
| N2 | 0.05 | 2 | 2.2 | 2 | 0.5 |
| N1 | 0.025 | 1 | 1.1 | 1 | 0.3 |

The following are some exemplary N value descriptions provided under ISO 1302:1992: N=10 (NiO=12.5 μm) indicates rough turned with visible toolmarks; N=8 (N8=3.2 μm) indicates smooth machined surface; N=7 (N7=1.6 μm) indicates static mating surfaces (or datums); N=6 (N6=0.8 μm) indicates bearing surfaces; and N=1 (N1=0.025 μm) indicates very fine lapped surfaces. In various embodiments, the surface roughness (Ra) value of the composite of the present disclosure is between the values of N=8 (N8=3.2 μm) and N=1 (N1=0.025 μm). In at least one embodiment, the “as-pressed” surface finish of the composite of the present disclosure is between N=8 (3.2 μm) and N=1 (N1=0.025 μm); stated differently, in at least one embodiment, the “as-pressed” surface finish of the composite can range from N1 (very fine lapped surface) and N8 (smooth machined surface). In various embodiments, the composite may be capable of holding a polished mirror surface upon proper finishing.

According to at least one embodiment, the composite has a flexural strength from about 10 MPa to 25 MPa, with a flexural strength from 12 MPa to 15 MPa being even more preferred.

According to at least one embodiment, the graphite that is present in the composite is aligned graphite wherein the graphite is aligned in a predetermined direction. In some embodiments, the alignment of graphite in such articles is achieved by roller forming and similar other techniques. In one embodiment, the alignment of graphite is a result of the pattern or way in which a 3D printer head is moved as the article is being 3D printed. In one embodiment, the alignment of graphite is a result of the way in which the granulated mixture is extruded through an extrusion head. In one embodiment, the alignment of graphite is achieved by uniaxial pressing or isostatic pressing. In various embodiments, the presence of aligned graphite may result in superior resistance to metal attack and mechanical toughness. In some embodiments, the presence of aligned graphite further provides a potential route to improve corrosion resistance of the manufactured article against fluxes, slag, and metal attack. In various embodiments, composites that include aligned graphite can result in the forming of articles that show superior corrosion resistance by forming such articles by methods that result in the formation of aligned graphite.

In various embodiments, the composite further has a non-wetting surface.

According to at least one embodiment, the composite is substantially net-shape.

In some embodiments, the carbon black, the flake graphite, the needle coke, and the binder system provide 100 percent of the total weight of the granulated mixture. In such an embodiment, no other components (including the ‘additives’ mentioned above) besides the carbon black, the flake graphite, the needle coke, and the binder system are present in the granulated mixture of the present disclosure. In such an embodiment, when such granulated mixture is shaped into a shaped body composed of the granulated mixture, and the shaped body is fired to provide a composite comprising graphite, the resulting composite has a total carbon content of at least 99%.

According to at least one embodiment, the composite has pores larger than 0.005 μm that are blocked with an anti-oxidation additive. According to at least one embodiment, the anti-oxidation additive in the article comprises a first anti-oxidation additive set comprising boron carbide, silicon carbide, aluminum-zinc phosphate, or any combination thereof, and a second anti-oxidation additive set, different from the first anti-oxidation additive set, and comprising zinc phosphate, aluminum phosphate, aluminum-zinc phosphate, or any combination thereof.

Preferably, at least part the composite is further coated with a coating. In other words at least part of the surface of the composite is coated with a coating. Advantageously, the coating is at least one selected from the group comprising: boron nitride, silicon carbide, alumina or alumina-titanate.

In some embodiments, the composite is infiltrated with a siloxane, a selected phosphate solution or any combination thereof.

In one embodiment, the composite comprising graphite is obtained by the method of the invention. According to at least one embodiment, the article is obtained from the composite as detailed above.

### DESCRIPTION OF THE DRAWINGS

FIG. 1 is a plot showing the granule size distribution of a granulated mixture in accordance with the present disclosure prior to firing and the pore size distribution in the part after firing. In some embodiments, and as is shown in FIG. 1 (see, for example, the far-left hand side labeled as ‘granule size in graphite mix’), the granulated mixture has a bimodal granule size distribution with a first set of granules having a granule size diameter from about 50 μm to about 100 μm, and a second set of granules having a granule size diameter from about 110 μm to about 1000 μm. The first set of granules can constitute from about 30 volume percent to about 60 volume percent of the total granulated mixture, while the second set of granules can constitute from about 20 volume percent to about 40 volume percent of the total granulated mixture (as noted elsewhere in this disclosure, the particle sizes expressed herein are D50 particle sizes, i.e., half the particles above the expressed value, and the other half is below the expressed value). FIG. 1 also shows the pore size distribution of the exemplary granulated mixture after firing.

FIGS. 2A and 2B are SEM (scanning electron microscope) images of a composite structure of graphite in accordance with an embodiment of the present disclosure showing that the graphite in the composite structure is aligned graphite. FIGS. 2A and 2B are SEM images showing graphite composites prepared in accordance with the present disclosure including aligned graphite. The use of alignment in graphite is well known in the manufacturing of crucibles as containers of molten metal. In some embodiments, the alignment of graphite in such articles is achieved by roller forming and similar other techniques. In one embodiment, the alignment of graphite is a result of the pattern or way in which a 3D printer head is moved as the article is being 3D printed. In one embodiment, the alignment of graphite is a result of the way in which the granulated mixture is extruded through an extrusion head. In one embodiment, the alignment of graphite is achieved by uniaxial pressing or isostatic pressing. In various embodiments, the presence of aligned graphite may result in superior resistance to metal attack and mechanical toughness. In some embodiments, the presence of aligned graphite further provides a potential route to improve corrosion resistance of the manufactured article against fluxes, slag, and metal attack. In various embodiments, composites that include aligned graphite can result in the forming of articles that show superior corrosion resistance by forming such articles by methods that result in the formation of aligned graphite.

FIG. 3 is a SEM image of a composite in accordance with an embodiment of the present disclosure in which clay and Al, Zn phosphate are located adjacent to needle coke. FIG. 3 is a SEM image of a composite in accordance with the present disclosure including aluminum-zinc phosphate ((Al, Zn)P) anti-oxidation additive (e.g., added as the first stage anti-oxidation additive and/or as the second stage anti-oxidation additive) located adjacent to needle coke. This SEM image shows that addition of the anti-oxidation additive closes the pores of the composite structure as is shown in FIG. 4. Notably, FIG. 4 which compares the pore size distribution of a basic composite S1 in accordance with the present disclosure with composites S2, S3 and S4 including various additives in accordance with embodiments of the present disclosure. The basic composite S1 was made from a granulated mixture of carbon black, flake graphite, needle coke and binder system only, while composite S2 was made from a granulated mixture of carbon black, flake graphite, needle coke, binder system and (Al, Zn)P, S3 was made from a granulated mixture of carbon black, flake graphite, needle coke, binder system, and (Al, Zn)P that was infiltrated after firing with a siloxane, and composite S4 was made from granulated mixture of carbon black, flake graphite, needle coke, and binder system that was infiltrated after firing with a siloxane. FIG. 4 shows that the addition of (Al, Zn)P to the granulated mixture of carbon black, flake graphite, needle coke, and binder system closes the pores by forming glass (Compare S1 to S2) or similar other glazed or glaze-like layer with a change in density from 1.64 g/cm³ for S1 to 1.67 g/cm³ for S2. FIG. 4 also shows that the infiltration of a siloxane into the granulated mixture of carbon black, flake graphite, needle coke, and binder system with or without the (Al, Zn)P closes all or most of the remaining pores (compare S3 with S2 and S1 with S4) with a change in density.

FIG. 4 is a plot comparing the pore size distribution of a basic composite in accordance with the present disclosure with composites including various additives in accordance with embodiments of the present disclosure.

FIGS. 5A and 5B are SEM images of a composite that includes a toughening/strength enhancing additive in accordance with an embodiment of the present disclosure. FIGS. 5A and 5B, there are provided SEM images of a composite that includes a toughening/strength enhancing additive (e.g., carbon fiber bundles) in accordance with an embodiment of the present disclosure. These SEM images show that the toughening/strength enhancing additive well bonded to the matrix graphite. Also, the oxidation package ensures good bonding and siloxane infiltration further strengthens the bond. The carbon fiber bundles participate in the fracture process to provide long crack bridging or toughness enhancement.

FIG. 6 is a SEM image of a composite that includes a wear/erosion agent in accordance with an embodiment of the present disclosure. FIG. 6, is a SEM image of a composite that includes a wear/erosion agent (e.g., zirconium oxide) in accordance with an embodiment of the present disclosure. The addition of wear/erosion agents (e.g., zirconium oxide) can react with the anti-oxidation additives to form erosion/oxidation resistant zircon (zirconium silicate, ZrSiO₄) and/or ZrSi glass.

FIG. 7 is a plot showing the pore size distribution of the composite shown in FIG. 6.

FIGS. 8A and 8B are SEM images of a composite that includes a thermal insulation enhancing agent in accordance with an embodiment of the present disclosure; FIG. 8A shows that the thermal insulation enhancing agent is dispersed in the granules of the granulated mixture used to provide the composite, while FIG. 8B shows that thermal insulation enhancing agent is located between the granules of the granulated mixture that is used to provide the composite. FIG. 8A shows that the thermal insulation enhancing agent is dispersed in the granules of the granulated mixture used to provide the composite S5, while FIG. 8B shows that thermal insulation enhancing agent is located between the granules of the granulated mixture that is used to provide the composite S6.

FIG. 9 is a plot showing the pore size distribution of the composites shown in FIGS. 8A (S5) and 8B (S6).

FIG. 10 is a bright phase image of a composite that includes NiP in accordance with an embodiment of the present disclosure.

FIG. 11 is a plot showing the pore size distribution of the composite of FIG. 10.

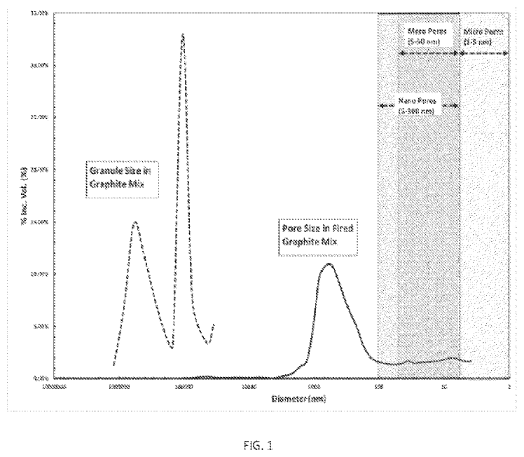

It is noted that the pore diameter shown in FIGS. 1, 4, 7, 9 and 11 is based on mercury (Hg) intrusion analysis, as detailed above.

### EXAMPLES

### Example 1

In this example, the granulated mixture was entirely composed of natural flake graphite of 88.0 weight percent, 7.0 weight percent medium molecular weight phenolic resin powder, and 5.0 weight percent dibasic ester. The natural flake graphite and phenolic resin were batched into a single hopper prior to being added to the mixer, the dibasic ester was kept separate. The dry components were added to the mixer and dry blended for approximately 2 minutes. After the dry blending, the dibasic ester component was added and the intensity of the mixer was increased. The mixing process was continued for approximately 30-45 min until the granulated mixture was sufficiently granulated. The loose fill density of the granulated mixture was measured as approximately 0.51 g/cm³. After cooling to room temperature, the granulated mixture was exposed to isostatic pressing at about 5,000 psi. The pressed shaped body had a green density of 1.6 g/cm³ with very green low strength. Increasing the phenolic resin and DBE resulted in a non-flowing powder which could not easily be formed into a shaped body. The shaped body was nevertheless cured at 200° C. but this only led to further weakening and eventual breakage of the shaped body.

### Example 2

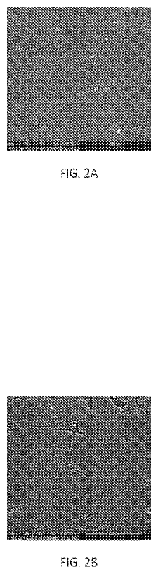

In this example, the granulated mixture contained a combination of natural flake graphite of 76.0 weight percent, carbon black of 7.5 weight percent, and needle coke of 3.0 weight percent, 7.5 weight percent medium molecular weight phenolic resin powder, and 5.0 weight percent dibasic ester. The dry components were batched into a single hopper prior to being added to the mixer, the dibasic ester was kept separate. The dry components were added to the mixer and dry blended for approximately 2 minutes. After the dry blending, the dibasic ester was added, and the intensity of the mixer was increased. The mixing process was performed for approximately 30-45 min until the granulated mixture was sufficiently granulated. The loose fill density of the mix was measured as approximately 0.65 g/cm³. After cooling to room temperature, the mix was exposed to isostatic pressing at about 5,000 psi. The pressed shaped body had a green density of 1.7 g/cm³ with easily handleable green strength. After pressing, the shaped body was cured at 200° C. The curing process causes the resin to crosslink which further increases the handling strength. The cured shaped body was exposed to a final firing cycle at 1200° C. for 4 hours. The resulting article comprised a pore profile as disclosed in the present disclosure. The surface roughness and profile were measured and are as disclosed in the earlier examples and figures, notably FIGS. 2A and 2B.

### Example 3

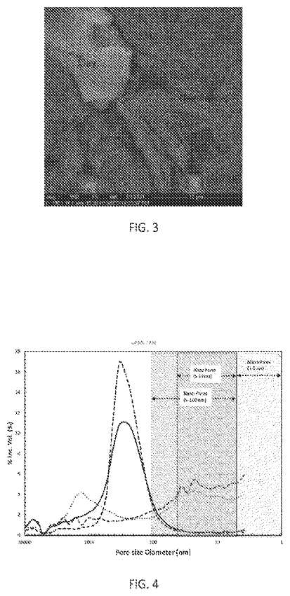

This example was performed according to the same process as Example 2, except that the pressed shaped body was infiltrated with a siloxane and/or phosphate solution after curing at 200° C. and fired once at 1200° C. The resulting composite (article) presented a pore size distribution as presented in FIG. 4.

### Example 4

This example was performed according to the same process as Example 2 except that the fired article was infiltrated with the siloxane and/or phosphate solution. After drying, the infiltrated article was fired for a second time at 1000° C. in carbonaceous environment. The resulting composite (article) presented a pore size distribution as presented in FIG. 4. Reference is also made to FIG. 3 showing a SEM image of a composite in accordance with this example in which clay and Al, Zn phosphate are located adjacent to needle coke.

The applicant noticed that infiltration treatment helped prevent oxidation of the carbon fibers during field application and also caused much of the coarser pores to close and thus resulted in an article with increased density.

### Example 5

In this example, the granulated mixture contained a combination of natural flake graphite of 76.0 weight percent, carbon black of 7.5 weight percent, and needle coke of 3.0 weight percent, 13.0 weight percent of liquid medium molecular weight phenolic resin mixture. The liquid phenolic resin was prepared by pre-mixing of phenolic resin with di basic ester in the ratio of 70:30 or with ethylene glycol in the ratio of 55:45. The dry components were batched into a single hopper prior to being added to the mixer and dry blended in the mixer for approximately 2 minutes. After the dry blending, the resin was added to the mixer and the intensity of the mixer was increased. The mixing process was performed for approximately 30-45 min until the granulated mixture was sufficiently granulated. The loose fill density of the granulated mixture was measured as approximately 0.65 g/cm³. After cooling to room temperature, the mix was exposed to isostatic pressing at about 5,000 psi. The pressed shaped body had a green density of 1.7 g/cm³ with easily handleable green strength. After pressing, the shaped body was transferred to a kiln and cured at 200° C. The curing process causes the resin to crosslink which further increases the handling strength. The cured shaped body was exposed to a final firing cycle at 1200° C. for 4 hours. The resulting article comprised a pore profile as disclosed in the present disclosure. The surface roughness and profile were measured and are as disclosed in the earlier examples and figures.

### Example 6

This example was performed according to the same process as Example 5, except that the pressed shaped body was infiltrated with a siloxane and/or phosphate solution after curing at 200° C. and fired once at 1200° C. The resulting article comprised a pore profile as disclosed in the present disclosure. The surface roughness and profile were measured and are as disclosed in the present patent application.

### Example 7

This example was performed according to the same process as Example 5, except that the fired article was infiltrated with, the siloxane and/or phosphate solution. After drying, the infiltrated article was fired for a second time at 1000° C. in carbonaceous environment. The applicant noticed that infiltration treatment helped prevent oxidation of the carbon fibers during field application and also caused much of the coarser pores to close and thus resulted in an article with increased density.

### Example 8

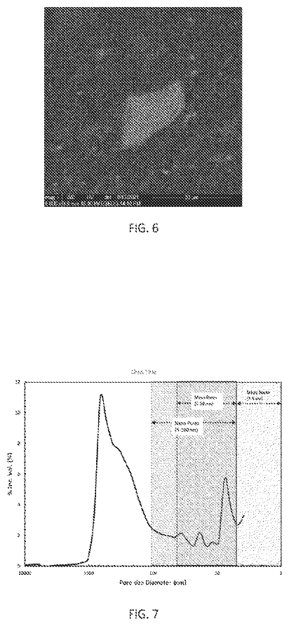

In this example, the granulated mixture contained a combination of natural flake graphite of 70.0 weight percent, carbon black of 6.0 weight percent, and needle coke of 2.0 weight percent, Boron carbide of 5.0 weight percent, silicon carbide of 3.3 weight percent, 7.0 weight percent medium molecular weight phenolic resin powder, and 5.0 weight percent dibasic ester. In this example, zirconia powder in the amount of 1.7 weight percent was added to the dry components. The dry components were batched into a single hopper prior to being added to the mixer, the dibasic ester was kept separate. The dry components were added to the mixer and dry blended for approximately 2 minutes. After the dry blending, the dibasic ester was added to the mixer and the intensity of the mixer was increased. The mixing process was performed for approximately 30-45 min until the granulated mixture was sufficiently granulated. The loose fill density of the mix was measured as approximately 0.68 g/cm³. After cooling to room temperature, the granulated mixture was exposed to isostatic pressing at about 5,000 psi. The pressed shaped body had a green density of 1.75 g/cm³ and with easily handleable green strength. After pressing, the shaped body was cured at 200° C. The curing process causes the resin to crosslink which further increases the handling strength. The cured shaped body was exposed to a final firing cycle at 1200° C. for 4 hours. Reference is made to FIG. 6 which is a SEM image of the composite that includes a wear/erosion agent in accordance with this example. The resulting article comprised a pore profile as showed in FIG. 7. The inventors found that the zirconia powder provided more wear resistance to the resulting article.

### Example 9

This example was performed according to the same process as Example 8, except that the pressed shaped body was infiltrated with a siloxane and/or phosphate solution after curing at 200° C. and fired once at 1200° C. The resulting article comprised a pore profile as disclosed in the present disclosure. The surface roughness and profile were measured and are as disclosed in the earlier examples and figures.

### Example 10

This example was performed according to the same process as Example 8, the fired article was infiltrated with the siloxane and/or phosphate solution. After drying, the infiltrated article was fired for a second time at 1000° C. in carbonaceous environment.

The applicant noticed that infiltration treatment helped prevent oxidation of the carbon fibers during field application and also caused much of the coarser pores to close and thus resulted in an article with increased density.

### Example 11

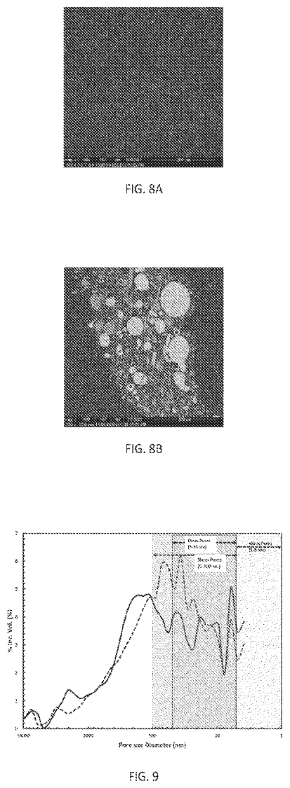

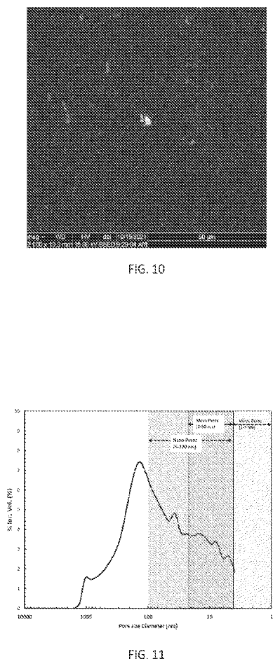

In this example, the granulated mixture contained a combination of natural flake graphite of 70.0 weight percent, carbon black of 6.0 weight percent, and needle coke of 2.0 weight percent, Boron carbide of 5.0 weight percent, silicon carbide of 3.3 weight percent, 7.0 weight percent medium molecular weight phenolic resin powder, and 5.0 weight percent dibasic ester. The dry components were batched into a single hopper prior to being added to the mixer, the dibasic ester was kept separate. The dry components were added to the mixer and dry blended for approximately 2 minutes. After the dry blending, the dibasic ester was added to the mixer and the intensity of the mixer was increased. The mixing process was performed for approximately 30-45 min until the granulated mixture was sufficiently granulated. Insulating alumino silicate fibers in an amount of 1.7 wt. % were added and mixing continued for an additional 1 or 2 minutes. The loose fill density of the granulated mixture was measured as approximately 0.63 g/cm³. After cooling to room temperature, the granulated mixture was exposed to isostatic pressing at about 5,000 psi. The pressed shaped body had a green density of 1.72 g/cm³ with easily handleable green strength. After pressing, the shaped body was cured at 200° C. The curing process causes the phenolic resin to crosslink which further increase the handling strength. The cured shaped body was exposed to a final firing cycle at 1200° C. for 4 hours. Reference is made to FIGS. 8A and 8B showing SEM images of a composite obtained in accordance with this example; FIG. 8A showed that the thermal insulation enhancing agent is dispersed in the granules of the granulated mixture used to provide the composite, while FIG. 8B showed that thermal insulation enhancing agent is located between the granules of the granulated mixture that is used to provide the composite. The pore size distribution of the composites is showed in FIG. 9.

### Example 12

This example was performed according to the same process as Example 11, except that the pressed shaped body was infiltrated with a siloxane and/or phosphate solution after curing at 200° C. and fired once at 1200° C. The resulting article comprised a pore profile as disclosed in the present disclosure. The surface roughness and profile were measured and are as disclosed in the earlier examples and figures.

### Example 13

This example was performed according to the same process as Example 11, except that the fired article was infiltrated with the siloxane and/or phosphate solution. After drying, the infiltrated article was fired for a second time at 1000° C. in carbonaceous environment.

The applicant noticed that infiltration treatment caused much of the coarser pores to close and thus resulted in an article with increased density.

### Example 14

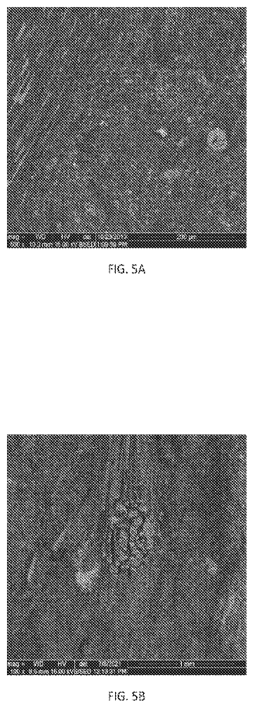

In this example, the granulated mixture contained a combination of natural flake graphite of 70.0 weight percent, carbon black of 6.0 weight percent, and needle coke of 2.0 weight percent, Boron carbide of 5.0 weight percent, silicon carbide of 3.5 weight percent, 7.0 weight percent medium molecular weight phenolic resin powder, and 5.0 weight percent dibasic ester. The dry components were batched into a single hopper prior to being added to the mixer, the dibasic ester was kept separate. The dry components were added to the mixer and dry blended for approximately 2 minutes. After the dry blending, the dibasic ester was added to the mixer and the intensity of the mixer was increased. The mixing process was performed for approximately 30-45 min until the granulated mixture was sufficiently granulated. 1.5 wt. % chopped carbon fiber bundles of length 6 mm and width 3 mm were added and mixing continued for an additional 1 to 2 minutes. The loose fill density of the granulated mixture was measured as approximately 0.63 g/cm³. After cooling to room temperature, the granulated mixture was exposed to isostatic pressing at about 5,000 psi. The pressed shaped body had a green density of 1.72 g/cm³ with easily handleable green strength. After pressing, the shaped body was cured at 200° C. The curing process causes the phenolic resin to crosslink which further increases the handling strength. The cured shaped body was exposed to a final firing cycle at 1200° C. for 4 hours. Reference is made to FIGS. 5A and 5B showing SEM images of a composite that includes a toughening/strength enhancing additive in accordance with an embodiment of the present disclosure.

The Applicant observed that both strength and toughness increased in comparison to graphite articles comprising no carbon fibers. The carbon fiber bundles were found to be strongly bonded to the graphite and participated in the fracture mechanisms. The surface roughness and profile were measured and are as disclosed in the earlier examples and figures.

### Example 15

This example was performed according to the same process as Example 14, except that the pressed shaped body was infiltrated with a siloxane and/or phosphate solution after curing at 200° C. and fired once at 1200° C.

### Example 16

This example was performed according to the same process as Example 14, except that the fired article was infiltrated with the siloxane and/or phosphate solution. After drying, the article was fired for a second time at 1000° C. in carbonaceous environment.

The applicant noticed that infiltration treatment was very important to prevent the oxidation of the carbon fibers during field application. As reported in the earlier examples, the infiltration treatment also caused much of the coarser pores to close and thus resulted in an article with increased density.

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure is not limited to the exact forms and details described and illustrated but fall within the scope of the appended claims.

1. A method of forming an article comprising a composite comprising graphite, wherein the article is suitable for containing or processing a molten metal, the method comprising:
(a) forming at least one granulated mixture by mixing at least carbon black, flake graphite, needle coke with at least one resin, wherein the at least one resin has a flow distance, as measured by ISO 8619:2003, from 20 mm to 150 mm;
(b) shaping the at least one granulated mixture into at least one shaped body; and
(c) firing the at least one shaped body.

2. The method of claim 1, wherein, relative to the total weight of the granulated mixture:
the carbon black is present in the granulated mixture in an amount from about 5 weight percent to about 10 weight percent,
the flake graphite is present in the granulated mixture in an amount from about 65 weight percent to about 85 weight percent,
the needle coke is present in the granulated mixture in an amount from about 1 weight percent to about 5 weight percent, and
the resin is present in the granulated mixture in an amount from about 2 weight percent to about 10 weight percent.

3. The method of claim 1, wherein, at least one solvent is added to the at least one resin to form at least one binder system consisting of the at least one resin and the at least one solvent.

4. The method of claim 3, wherein the at least one solvent is present in the granulated mixture in an amount from about 1 weight percent to about 5 weight percent, relative to the total weight of the granulated mixture.

5. The method of claim 1, wherein the at least carbon black, the flake graphite, the needle coke, and the at least one resin provide 100 percent of a total weight of the granulated mixture.

6. The method of claim 1, wherein the at least one granulated mixture further comprises from about 5 weight percent to about 15 weight percent of at least one anti-oxidation additive, relative to the total weight of the granulated mixture, wherein optionally the at least one anti-oxidation additive comprises boron carbide, silicon carbide, aluminum-zinc phosphate, or any combination thereof.

7. The method of claim 1, wherein the at least one granulated mixture further comprises from about 1 weight percent to about 5 weight percent of at least one toughening/strength enhancing additive, relative to the total weight of the granulated mixture, wherein optionally the at least one toughening/strength enhancing additive comprises carbon fibers, chopped carbon fiber bundles, basalt bundles, alumina silicate fibers, chopped steel fibers or any combination thereof.

8. The method of claim 1, wherein the granulated mixture further comprises from about 1 weight percent to about 10 weight percent of at least one wear/erosion resistance agent, relative to the total weight of the granulated mixture, wherein optionally the at least one wear/erosion resistance agent comprises a metal oxide, a metal nitride, a metal boride, or any combination thereof.

9. The method of claim 1, wherein the at least one granulated mixture further comprises from about 1 weight percent to about 5 weight percent of a thermal insulation enhancing agent, relative to the total weight of the granulated mixture, and wherein optionally the at least one thermal insulation enhancing agent comprises colloidal silica shots, preferably alumino colloidal silicate shots, fibers, preferably a mixture of sodium and chopped silica fibers, or a mixture thereof.

10. The method of claim 1, wherein at least part of the composite is infiltrated with a siloxane, a selected phosphate solution or any combination thereof prior to, or after, the firing step.

11. The method of claim 1, wherein the resin is phenolic resin, wherein optionally the phenolic resin is a liquid phenolic resin.

12. An article comprising a composite comprising graphite, wherein the composite has a total pore volume and a pore size distribution, measured according to ASTM C830-00(2016) Standard, wherein at least 95 percent of the total pore volume is contained in pores with a diameter of less than 1 μm, and at least 40 percent of the pore volume of the pores having a diameter of less than 1 μm is contained in pores having a diameter of less than 0.1 μm.

13. The article of claim 12, wherein the composite has a density from about 1.6 g/cm³ to about 1.92 g/cm³.

14. The article of claim 12, wherein the composite has 65% or more of graphite.

15. The article of claim 12, wherein the composite has a surface roughness Rₐ between 3.2 μm and 0.025 μm, wherein the surface roughness Rₐ is measured based on the ISO 1302:1992 standard.

16. The article of claim 12, wherein at least part the composite is further coated with a coating.

17. The article of claim 12, wherein the article is a crucible, said crucible being comprised of a plurality of crucible rings which are stacked uniformly on top of one another in order to provide the crucible.

18. An article comprising a composite comprising graphite obtained by the method of claim 1.

19. The article of claim 18 wherein the composite has a total pore volume and a pore size distribution, measured according to ASTM C830-00(2016) Standard, wherein at least 95 percent of the total pore volume is contained in pores with a diameter of less than 1 μm, and at least 40 percent of the pore volume of the pores having a diameter of less than 1 μm is contained in pores having a diameter of less than 0.1 μm.

20. The article of claim 18 wherein at least part the composite is further coated with a coating.

21. (canceled)
